(19) United States
(12) Patent Application Publication
(10) Pub. No.: US 2008/0294741 A1
(43) Pub. Date: Nov. 27, 2008

(54) Method of dynamically evaluating the mood of an instant messaging user

(75) Inventors: Martinho Dos Santos, Thorigne-Fouillard (FR); Yann Gestraud, Rennes (FR); Herve Texier, Noyal Chatillon Sur Seiche (FR)

Correspondence Address: COHEN PONTANI LIEBERMAN & PAVANE LLP, Suite 1210, 551 Fifth Avenue, New York, NY, 10176, US

(73) Assignee: France Telecom, Paris (FR)

(21) Appl. No.: 12/154,401

(22) Filed: May 22, 2008

(30) Foreign Application Priority Data
May 25, 2007 (FR) 0755254

(51) Int. Cl. G06F 15/16

(52) U.S. Cl. 709/206

(57) ABSTRACT

A method of dynamically evaluating the mood of a user of an electronic messaging system who uses a terminal to send an electronic message addressed to another user, the sending user having an element representative of that user's mood that is visible to the addressee of the message, and in general manner, by all of the contacts of the sending user. The sent message transits via a platform that includes a module for evaluating the mood of users, which module modifies a parameter measuring the mood of the user sending the message as a function of at least one predetermined criterion present in the sent message. The modified parameter is notified to the addressees of the message and to all or some of the contacts of the sending user.

### FIELD OF THE INVENTION

The present invention relates to the field of services for exchanging electronic messages such as instant messaging services or “chat” services (services enabling conversation in real time). The invention relates more particularly to enriching the presence information in such systems.

### BACKGROUND OF THE INVENTION

Real time electronic conversation systems, such as instant messaging, enable users to exchange messages in real time. A standard instant messaging service comprises an instant messaging platform or server to which the users are connected via respective instant messaging clients. The platform has a main instant messaging module for exchanging messages between instant messaging clients as a function of rules for routing instant messages. The module also manages the presence status of each of the contacts (also referred to as “buddy list”) recorded with the instant messaging service.

The presence/availability status of a user is a parameter that is visible to the other users. This status can vary in general between a “present” status and an “absent” status, or between an “available” status and a “busy” status. For all of the contacts in the user's buddy list, these presence statuses define their respective capacities to enter into dialog with the user.

In some instant messaging services, users also have an option enabling them in particular to specify their current mood. This may be represented by an expressive avatar or by text indicating how they are feeling.

Nevertheless, managing such a parameter is up to the user who is obliged to configure this parameter manually in order to make it pertinent. Management of mood information, when performed manually by the user, in particular while in an instant conversation with other users, can rapidly become tedious. During an exchange of instant messages, the user's mood can change several times as the conversation proceeds. The user cannot simultaneously engage in real-time conversation and continue managing mood information. Consequently, most of the time, users do not manage information about their mood, and as a result that mood information is rarely pertinent.

### OBJECTS AND SUMMARY OF THE INVENTION

A particular object of the present invention is to mitigate the above-described drawbacks by proposing a solution that makes it possible in pseudo-real time to evaluate automatically the mood of a user in an instant messaging service.

To this end, one aspect of the present invention provides a method of dynamically evaluating the mood of a user of an electronic messaging system, the method including at least a step of the user sending an electronic message to at least one addressee, the user having an element representative of the user's mood that is visible by at least one addressee of the message, in which method, a parameter measuring the mood of the message-sending user is modified as a function of at least one predetermined criterion present in the message sent by said user, said modified parameter being notified to said at least one addressee of the message.

Thus, in order to evaluate the mood of a user, the method of the present invention advantageously makes use of elements that are present in the instant messages sent by that user. In this way, there is no longer any need for the user to intervene to update the mood made visible to the other users, since said mood is updated automatically as a function of predetermined criteria present in the messages.

Instant messages are often enriched by elements that are directly representative of the mood of the writer, such as for example emoticons (of the “smiley” type), punctuation such as exclamation marks, capital letters, specific sizes or colors for characters, etc. With the method of the invention, all or some of these elements can be used as criteria for modifying the mood measurement parameter, thus making it possible in quasi-real time to inform the contacts of the user about the user's mood by notifying the mood measurement parameter to them as soon as it is modified. This provides information that is realistic and pertinent about the mood of a user.

Furthermore, with the exception of key words, the criteria present in the instant message and used for modifying the mood measurement parameter, such as for example emoticons or punctuation, are independent of the language used and are to be found in a very large number of countries. The method of the invention can thus be implemented simply without it being necessary to use a semantic dictionary.

In addition to the addressee(s) of the message, the mood measurement parameter can naturally also be notified to all or some of the contacts included in the buddy list of the user of the instant messaging service.

In an aspect of the invention, the mood measurement parameter is also modified as a function of a plurality of mood evaluation rules executed in a determined order, each evaluation rule modifying the mood measurement parameter of said user in the event of at least one criterion associated with each rule being satisfied. In a variant, when a plurality of criteria are associated with a rule, the actions defined by the rule for modifying the mood measurement parameter are performed only if all of the associated criteria are satisfied.

In this way, it is possible to establish a priority order in which criteria used for modifying the mood measurement parameter are applied. Thus, the modifications applied to the mood measurement parameter by executing a rule are additional to any modifications that have been already applied by any previously executed rule(s). This makes it possible in particular to execute an evaluation rule for accentuating or attenuating the intensity of a mood after some other evaluation rule has been used for defining the kind of mood.

According to another aspect of the invention, the mood measurement parameter is also modified after a predetermined duration without the user sending a message or after a predetermined duration during which the user has sent messages without any predetermined criterion.

The method of the invention can thus also take account of time as a criterion for modifying the mood measurement parameter, in particular in order to allow a return to a neutral mood in the event of the user being inactive or in the event of messages being exchanged that are not significant concerning mood, i.e. messages without predetermined criteria (emoticons, punctuation, etc.).

The mood measurement parameter may be modified by moving a cursor on a disk that is subdivided into sectors, each sector corresponding to a respective kind of mood, and the distance between the center of the disk and the cursor corresponding to the intensity of the mood. The use of such a disk makes it possible to have means available for qualifying and for quantifying the mood of a user, which means can be interpreted directly by users, and can consequently also be used as an element representative of mood made visible to users on their terminals.

In a variant, the element representative of mood is visible by the sender of the message, and said modified parameter is notified to the sender of the message. In this way, the sender of the message knows the mood that is being associated with him/her and that is displayed on the terminals of addressees.

The method of the invention may be implemented by a computer program executed on processor means of a messaging platform or service, the program comprising instructions for executing the steps of the above-described method.

The above-described program may be stored on a data medium in the form of a series of program code instructions for executing the above-described method when said program is executed on a computer, and more particularly on processor means on a messaging platform or server.

An aspect of the invention also provides an instant messaging platform comprising means for conveying at least one electronic message sent by a user addressed to at least one addressee, the platform further comprising means for modifying a parameter measuring the mood of the user sending the message as a function of at least one predetermined criterion present in the message sent by said user, and for notifying said parameter to said at least one addressee of the message.

As explained above for the method of the invention, the platform of the present invention makes it possible to evaluate automatically the mood of a user by advantageously making use of elements present in the instant messages sent by the user, thus enabling information about the mood of the user to be updated almost in real time. With the platform of the invention, the ability to inform the contacts of a user in an instant messaging service becomes genuinely attractive because of the simplicity with which it can be implemented.

The platform may further comprise means for modifying the mood measurement parameter after a predetermined duration without the user sending a message or after a predetermined duration during which the user has sent messages without a predetermined criterion, thus making it possible in particular to avoid displaying mood information that has become obsolete.

An aspect of the invention also provides an electronic messaging client computer program for executing on a computer terminal of a user, said program comprising instructions enabling electronic messages to be written, sent, and received, the program further comprising instructions for displaying an element representative of the mood of at least one contact in the user's buddy list, and instructions for modifying said mood-representing element as a function of at least one mood measurement parameter received by the terminal.

Thus, by means of the electronic messaging client computer program of the invention, each user has available on his or her own terminal an element for viewing the mood of one or more contacts, the mood-representing element being modified automatically on receiving a mood measurement parameter as transmitted with the enriched presence status information.

In an aspect of the electronic messaging client computer program of the invention, the program further comprises instructions for displaying an element representative of the mood of the user of the terminal on which said program is executed, and it comprises instructions for modifying said element representing the mood of said user as a function of at least one mood measurement parameter received by the terminal or in response to an update command executed locally on the terminal. The user can thus see how his or her own mood is varying and can intervene manually on said mood, where appropriate.

Finally, the invention provides a computer terminal (e.g. a computer) comprising means enabling electronic messages to be written, sent, and received, the terminal further comprising means for displaying an element representative of the mood of at least one contact in the contact list of the user of said terminal, and instructions for modifying said mood-representing element as a function of at least one mood measurement parameter received by the terminal.

According to an aspect of the invention, the terminal further comprises means for displaying an element representative of the mood of the user of said terminal and means for modifying said element representative of the mood of said user as a function of at least one mood measurement parameter received by the terminal or in response to an updating command executed locally on the terminal.

In a variant, the terminal comprises means for displaying an element representative of the mood of the user of said terminal.

### BRIEF DESCRIPTION OF THE DRAWINGS

Other characteristics and advantages of the invention appear from the following description of particular embodiments of the invention, given as non-limiting examples, with reference to the accompanying drawings, in which:

FIG. 1 is an overall diagrammatic view of an embodiment of an instant messaging service of the invention;

FIG. 2 shows a disk for measuring mood in accordance with an embodiment of the invention; and

FIG. 3 is a flow chart showing the steps implemented in the method of dynamically evaluating the mood of a user in an implementation of the invention.

### DETAILED DESCRIPTION OF THE DRAWINGS

The present invention applies particularly but not exclusively to instant electronic conversation systems such as instant messaging services or “chat” services. The invention proposes incorporating functions essentially in software form in the messaging servers or platforms commonly in use for implementing exchanges of instant messages between users. The functions proposed are compatible with the standards and protocols presently used by instant conversation services, thus enabling these new functions to be incorporated equally well in new systems and in instant conversation systems that are already in place.

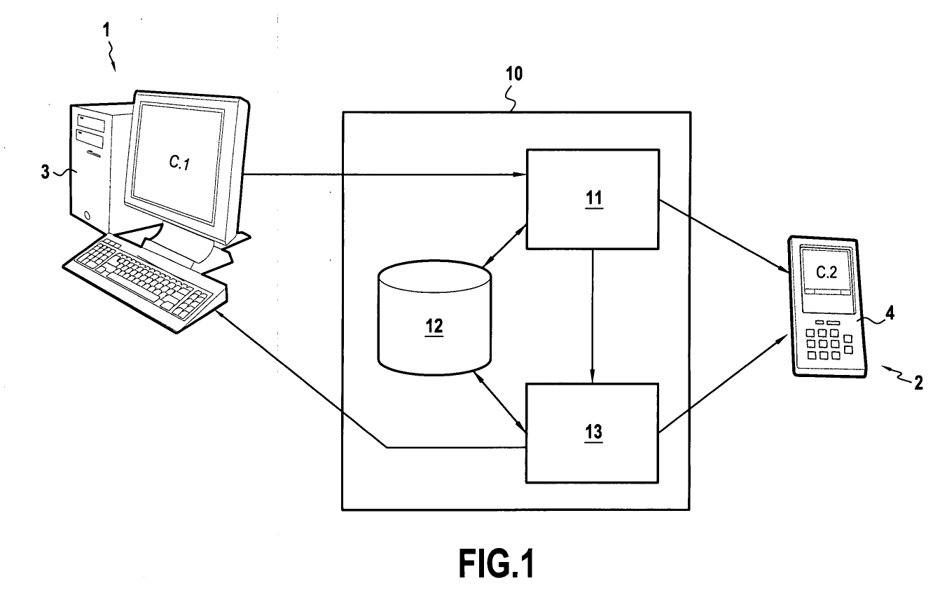

FIG. 1 is a general functional diagram of a system of the invention showing the various portions involved in the method of the invention. The system of the invention as described herein is implemented in an instant messaging service. The parties who are mainly involved during an operation of dynamically evaluating the mood of a user are at least two users 1 and 2, each possessing a respective terminal 3, 4 provided with an instant messaging client C_1, C_2. Each of the terminals 3 and 4 is in communication with an instant messaging platform 10 that enables instant messages to be exchanged between these two terminals.

In the example shown in FIG. 1, the users 1 and 2 have as their terminals for sending and receiving messages, respectively a fixed terminal 3 of the personal computer (PC) type connected to a computer network, and a mobile terminal 4 of the communicating personal digital assistant (PDA) or mobile telephone type. Nevertheless, the present invention applies in general manner to all terminals that include means for sending and receiving instant messages via a communications network.

In known manner, the instant messaging client (or user agent) is software that enables a user to use a personal identifier to access an instant messaging service via the instant message platform 10. The instant messaging client makes it possible in particular to write and to receive messages. It also enables the user to access the instant messaging platform in order to manage the user's own presence status with respect to an associated buddy list. In accordance with the present invention, the instant messaging client also includes means for displaying an element that is representative of the mood of users in the buddy list of the user of the messaging client, said representative element being constituted by text, a numerical value, an “emoticon” or “smiley”, a color, etc. The messaging client of the invention further includes means for displaying an element representative of the mood of the messaging client user, and means for enabling the user to modify said element manually.

The communications network (not shown) through which the terminals of the users are connected to the instant messaging platform may be an “open” network such as the Internet, or a “closed” network such as a business network of the Intranet type, or indeed it may be a partially open network making use both of a closed network and of an open network.

The platform 10 may be implemented within an instant messaging service. The platform 10 comprises a main instant messaging module 11 that is a software element that is well known of itself, and that is designed to route instant messages between the messaging users in application of routing rules for the instant messages (transfer agent). The module 11 also manages the presence of users of the messaging service by updating the presence status of each user in a database 12.

In accordance with an embodiment of the invention, the platform 10 also comprises a module 13 for evaluating the mood of users, thus making it possible, as explained in detail below, to evaluate dynamically the mood of a user of the instant messaging service and to notify this mood to the other users. In a variant, the mood of the sender of a message is also visible to the sender. The user mood evaluation module 13 is a software element that comprises a series of evaluation rules that are performed in a determined order to evaluate automatically the mood of a user of the messaging service. The mood of the sender is evaluated from messages sent by the sender when they are “text” type messages. The term “text” type message is used herein to mean any message comprising letters, characters, graphics signs, emoticons, etc. The module 13 also includes a parser which, in known manner, is a computer program that serves to extract key elements from messages for use by the mood evaluation rules. For example, the parser is used to isolate emoticons or “smileys”, exclamation marks, and words in capital letters, which are considered as being message elements that are representative of the author's mood (predetermined criteria of the mood evaluation rules).

To enable the mood of a user to be evaluated, i.e. measured, it must be possible to quantity mood with the help of a mood parameter that is both qualitative and quantitative, referred to below as the “mood measurement parameter”, which parameter is modified as a function of one or more predetermined criteria corresponding to at least one element extracted from the text type message.

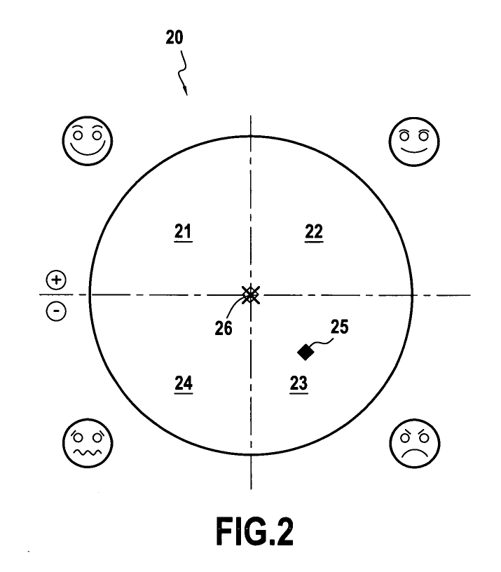

For this purpose, the invention proposes, in particular, defining the mood of a user as a function of the position of a cursor on a disk, this position corresponding to the value of the mood measurement parameter. FIG. 2 shows an example of a disk 20 subdivided into four mood poles or sectors 21 to 24, here corresponding respectively to happiness, laughter, anger, and sadness, with a cursor 25 being movable thereover. The center 26 of the disk 20 represents a neutral mood state towards which the cursor 25 moves little by little in the event of user inactivity. The minimum degree of evaluation consists in determining whether the user's mood is more positive or more negative (corresponding to being in a good mood or in a bad mood, in the usual sense), depending on whether the cursor 25 is in the top half or the bottom half to the disk 20. The position of the cursor 25 in one of the sectors 21 to 24 specifies the kind of mood the user is in, whereas the distance of the cursor from the center is proportional to the intensity of the mood. In the example shown in FIG. 2, the cursor 25 is in the negative part of the disk 20, within the sector 23, and at a distance that is relatively close to the center 26. This means that the user is in a bad mood and somewhat angry.

The above-described disk represents but one possible parameter tool amongst other that can be used for measuring the mood of a user. The mood measurement parameter could equally well correspond merely to a number of sign that specifies the kind of mood (negative=bad mood, 0=neutral, positive=good mood) and of value that indicates the intensity of the mood (low to strong). Similarly, mood can be evaluated as a function of a color (red=bad mood, white=neutral, green=good mood) and of its intensity (pale color=mood of low intensity, dark color=mood of strong intensity).

The user mood evaluation module 13 contains a set of previously-defined mood evaluation rules, e.g. as provided by the provider of the instant messaging service, which rules, on being executed sequentially, serve to evaluate the mood of a user. The evaluation rules are constituted by corresponding criteria and actions. In this embodiment, if all of the criteria associated with the rule are satisfied, then the corresponding action is performed.

The order in which the rules are declared defines their priority and the order in which they are executed. Rule n declared before rule n+1 is executed beforehand, and the criterion (criteria) for rule n+1 take(s) account of the actions accomplished by rule n. Similarly, if the criterion (criteria) of rule n+1 are satisfied, then its actions will be additional to those that might already have been applied beforehand.

The previously-defined evaluation rules serve to modify the mood measurement parameter. With the disk as described above, the execution of these rules serves to move the cursor over the disk, the position of the cursor on the disk being directly representative of the mood of the user in question. By way of example, each rule contains instructions for modifying the polar coordinates (r, θ) of the cursor on the disk in the event of the criterion (criteria) associated with that rule being satisfied, thus making it possible to move the cursor towards the corresponding mood sector (value for the angle θ) and with the corresponding intensity (distance value r).

With a mood measurement parameter corresponding, by way of example, to a mere numerical value of sign that indicates the kind of mood (negative=bad mood, 0=neutral, positive=good mood), and of value that indicates the intensity of the mood (low to strong), each evaluation rule has instructions that are implemented when the criterion (criteria) associated with the rule is/are satisfied to modify the original numerical value or the value as already modified by a previously-executed rule.

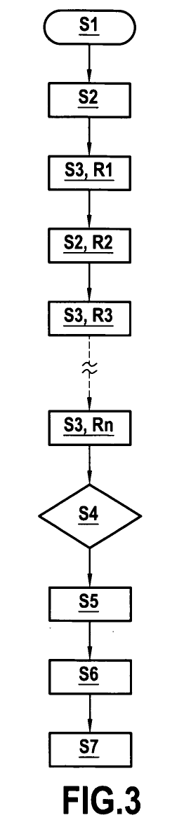

With reference to FIG. 3, there follows a description of an implementation of the method of the invention in the system of FIG. 1 in the event of user 1 sending a message to user 2. In the implementation described below, mood is represented by means of the above-described disk 20.

In a first step S1, the user 1 makes use of a messaging client C_1 in the terminal 3 to write and send an instant message to the user 2. The message as sent passes via the platform 10 which parses its content in order to determine whether any of the key elements are present (step 2). More precisely, the main instant messaging module 11 duplicates the message sent by the user 1 and forwards it both to the terminal 4 of the user 2 and to the user mood evaluation module 13. The module 13 makes use of its parser to extract from the message any predetermined element that corresponds to criteria associated with the mood evaluation rules, such as, for example: emoticons, previously-defined key words, exclamation marks, words in capitals.

Once the predetermined elements have been extracted from the message, the series of mood evaluation rules previously programmed in the module 13 is applied. As explained above, the evaluation rules are stored in a determined order. The module 13 executes the first evaluation rule of the rule series (step S3.R1). The following evaluation rule is then executed (step S3.R2), taking account of the modification, if any, made to the mood measurement parameter by the previously executed rule in the event of the criterion (criteria) associated with said rule being certified.

The table below gives an example of a series of mood evaluation rules that are executed in the order given by their numbers, the mood measurement parameter being manifested on the above-described disk 20.

| Evaluation | | |
|---|---|---|
| rules | Criteria (criterion) | Resulting action |
| Rule No. 1 | The message contains an | The cursor is positioned in |
| | emoticon (e.g. [symbol] ). | a mood sector 21 to 24 of |
| | | the disk 20 that corresponds |
| | | to the meaning of the |
| | | emoticon (e.g. the if the |
| | | message contains the |
| | | smiley emoticon [symbol] , |
| | | the cursor 25 |
| | | moves into sector 21 |
| | | (“happiness”) at a distance |
| | | from the sector 26 that is |
| | | defined by the weight given |
| | | to the emoticon [symbol] ) |
| Rule No. 2 | The message contains | The key words are |
| | certain key words defined | processed like emoticons, |
| | by the service provider. | by considering their |
| | | meanings. |
| | | (The service provider has |
| | | previously defined a certain |
| | | number of key words |
| | | associated with each |
| | | emoticon.) |
| Rule No. 3 | The message contains one | The cursor stays on the |
| | or more exclamation | same axis in its mood |
| | marks. | sector, but it moves |
| | | from the center 26 |
| | | through a distance equal to |
| | | half the distance between |
| | | the cursor and the edge of |
| | | the disk, and it does this |
| | | as many times as there are |
| | | exclamation marks. |
| Rule No. 4 | The message contains | The cursor moves a little |
| | words in capitals. | away from the center 26. |
| Rule No. 5 | The user has been | The cursor moves towards |
| | inactive for a certain | the center 26, halving the |
| | length of time (defined | distance between the cursor |
| | by the provider). | and the center. |
| Rule No. 6 | No key elements in | The cursor moves towards |
| | messages that have been | neutral through half the |
| | sent over a certain | distance between the cursor |
| | length of time (defined | and neutral. |
| | by the provider). | |

When all of the module evaluation rules defined in module 13 have been executed (steps S3.R1 to S3.Rn), the module 13 verifies whether the resulting mood is different from the mood known prior to executing the rules by comparing the resulting mood measurement parameter with the parameter as it was before the rules were executed. In the example described herein, the module 13 compares the position of the cursor 25 on the disk 20 after execution of the rules with its stored position prior to execution of the rules (step S4). If there is no difference between the position of the cursor 25 before and after execution of the rules, no action is undertaken.

If the mood measurement parameter is different after the rules have been executed, then the module 13 updates the presence status of the user by enriching it with the user's new mood as calculated in this way. More precisely, the mood measurement parameter for user 1 that results from executing the evaluation rules can be inserted together with presence status data for the user that is already present in the database 12 (step S5). In this way, the updated mood measurement parameter can be broadcast to the user's contacts and to the user him or herself together with the presence status (step S6). This makes it possible to use presence status broadcast mechanisms that already exist in the messaging service for transmitting the user's mood.

The messaging clients of users receiving the presence status together with the parameter representative of the mood of user 1, here client C_1 of user 1 (sender of the message) and C_2 of user 2 (destination of the message), automatically modify their elements representative of the mood of user 1 as a function of the value of the mood measurement parameter received with the presence status (step S7). Thus, user 2 is informed about the mood of user 1 at the time the message was sent, and user 1 can also see on his or her own terminal the mood state as seen by user 2. The element representative of mood that is displayed on the terminal of each user can be a disk similar to the disk 20 in which the cursor is positioned at a function of the value (polar coordinate) of the mood measurement parameter as transmitted. This element representative of mood may also be in the form of an avatar or of an image. Under such circumstances, the received mood measurement parameter is interpreted by the messaging client of the terminal to modify the avatar accordingly, for example either by using a library of images or photographs of the user, or by using a (2D or 3D) graphics animation.

The instant message sent by user 1 (step S1) is transmitted to the user 2 by the main messaging module 11 in parallel with performing the step of evaluating mood (steps S2 to S7) as described above. In other words, the parsing of messages by the user mood evaluation module 13 does not slow down the transmission of messages between users, so the instant messaging service operates normally without troubling its users.

For reasons of simplification, the system shown in FIG. 1 is shown as having two instant messaging clients. Nevertheless, from the above description, the person skilled in the art will have no difficulty in implementing such a system on a larger scale, i.e. with a larger number of users.

What is claimed is:

1. A method of dynamically evaluating the mood of a user of an electronic messaging system, the method including at least a step of the user sending an electronic message to at least one addressee, the user having an element representative of the user's mood that is visible by at least one addressee of the message, wherein a parameter measuring the mood of the message-sending user is modified as a function of at least one predetermined criterion present in the message sent by said user, and wherein said modified parameter is notified to said at least one addressee of the message.

2. A method according to claim 1, wherein the mood measurement parameter is also modified as a function of a plurality of mood evaluation rules executed in a determined order, each evaluation rule modifying the mood measurement parameter of said user in the event of at least one criterion associated with each rule being satisfied.

3. A method according to claim 1, wherein the mood measurement parameter is also modified after a predetermined duration without the user sending a message or after a predetermined duration during which the user has sent messages without any predetermined criterion.

4. A method according to claim 1, wherein the mood measurement parameter is modified by moving a cursor on a disk that is subdivided into sectors, each sector corresponding to a respective kind of mood, and the distance between the center of the disk and the cursor corresponding to the intensity of the mood.

5. A method according to claim 1, wherein the element representative of mood is visible by the sender of the message, and wherein said modified parameter is notified to the sender of the message.

6. An instant messaging platform comprising means for conveying at least one electronic message sent by a user addressed to at least one addressee, the platform further comprising means for modifying a parameter measuring the mood of the user sending the message as a function of at least one predetermined criterion present in the message sent by said user, and for notifying said parameter to said at least one addressee of the message.

7. A platform according to claim 6, further comprising means for modifying the mood measurement parameter after a predetermined duration without the user sending a message or after a predetermined duration during which the user has sent messages without a predetermined criterion.

8. A computer program including at least one series of computer code instructions for executing a method according to claim 1 when said program is executed on a computer.

9. A data medium having stored thereon at least one series of program code instructions for executing a method in accordance with claim 1 when said program is executed on a computer.

10. An electronic messaging client computer program for executing on a computer terminal of a user, said program comprising instructions enabling electronic messages to be written, sent, and received, the program further comprising instructions for displaying an element representative of the mood of at least one contact in the user's buddy list, and instructions for modifying said mood-representing element as a function of at least one mood measurement parameter received by the terminal.

11. A computer program according to claim 9, further comprising instructions for displaying an element representative of the mood of the user of the terminal on which said program is executed, and comprising instructions for modifying said element representing the mood of said user as a function of at least one mood measurement parameter received by the terminal or in response to an update command executed locally on the terminal.

12. A computer terminal comprising means enabling electronic messages to be written, sent, and received, the terminal further comprising means for displaying an element representative of the mood of at least one contact in the contact list of the user of said terminal, and instructions for modifying said mood-representing element as a function of at least one mood measurement parameter received by the terminal.

13. A terminal according to claim 12, further comprising means for displaying an element representative of the mood of the user of said terminal and means for modifying said element representative of the mood of said user as a function of at least one mood measurement parameter received by the terminal or in response to an updating command executed locally on the terminal.

14. A terminal according to claim 12, comprising means for displaying an element representative of the mood of the user of said terminal.
